(19) United States
(12) Patent Application Publication
(10) Pub. No.: US 2020/0305638 A1
(43) Pub. Date: Oct. 1, 2020

(54) SYSTEMS AND METHODS FOR SHARING PARAMETERS DEFINING A COOKING PROCESS ON THE INTERNET

(71) Applicant: Shah N. Husain, Brampton (CA)

(72) Inventor: Shah N. Husain, Brampton (CA)

(21) Appl. No.: 16/548,200

(22) Filed: Aug. 22, 2019

Related U.S. Application Data
(60) Provisional application No. 62/825,979, filed on Mar. 29, 2019.

(51) Int. Cl. A47J 36/32; G06F 9/451; G05B 15/02; H04L 29/08

(52) U.S. Cl. CPC A47J 36/32; G06F 9/451; G06F 16/953; H04L 67/12; G05B 15/02

(57) ABSTRACT

A computer-assisted cooking method is provided. The method comprises operating a chef-side computer system to collect cooking session information from a chef cooking session; uploading to, and storing on, a remote server the cooking session information; and receiving at the remote server, a request from a user-side computer system for the cooking session information, and, in response, downloading the cooking session information the user-side computer system.

### CROSS-REFERENCE TO RELATED APPLICATION

This application claims the benefit of U.S. Provisional Patent Application No. 62/825,979 filed Mar. 29, 2019, the contents of which are incorporated herein by reference.

### FIELD

The described embodiments relate to systems and methods for sharing critical, dynamic parameters (“DNA of Recipe”) defining the cooking process of a particular recipe on the Internet.

### Introduction

This invention relates to the Internet of Things (IOT). In general, the IOT is the network of physical objects or “things” embedded with data gathering sensors, micro-controller and software, and communication interface for network connectivity. Each thing is uniquely identifiable through its embedded system, enabling it to be sensed and controlled remotely across existing network infrastructure. The things can exchange data and interoperate within the existing Internet infrastructure.

### BRIEF DESCRIPTION OF THE DRAWINGS

A preferred embodiment of the present invention will now be described in detail with reference to the drawings, in which:

FIG. 1, in a schematic view, illustrates a computer-implemented system in accordance with an embodiment of the invention;

FIG. 2, in a schematic view and aligned graphs illustrates corresponding chef-side and user-side time lines for temperature and other cooking parameters;

FIG. 3, in a perspective view, illustrates an example embodiment of the Temperature Data Logger;

FIG. 4, in a perspective view, illustrates an example embodiment of the Temperature Controller;

FIG. 5, in a schematic view, illustrates a computer-implemented system in accordance with another embodiment of the invention; and

FIG. 6, in a schematic view, illustrates a computer-implemented system in accordance with yet another embodiment of the invention.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

In embodiments, aspects of methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computer (referred to below as data processor) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

The described embodiments relate to using IOTs to address a need to precisely reproduce cooked food following a recipe anytime, anywhere in the world. Such precise reproduction of cooked food can be facilitated by saving critical, dynamic parameters (hereafter referred to as the “DNA of Recipe”) defining the cooking process of a particular recipe on the Internet for later downloading, anytime, anywhere in the world.

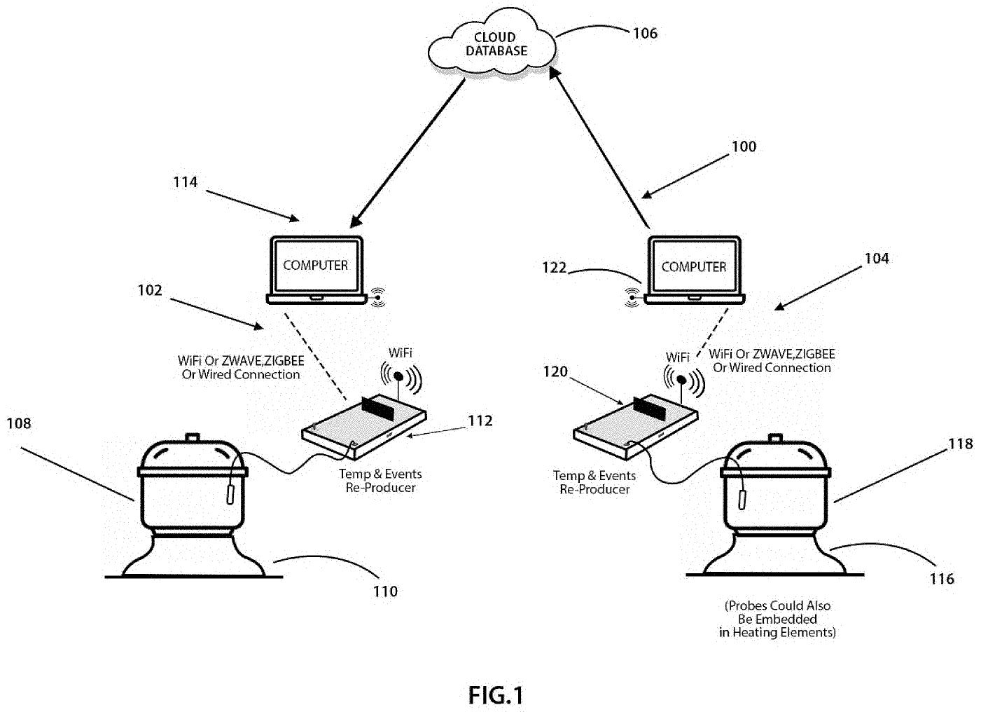

Reference is first made to FIG. 1 showing a system 100 for sharing parameters defining a cooking process on the Internet (the Kookken™ system). The system 100 includes a chef or uploading side 104 (bottom-right corner of FIG. 1), a user or downloading side 102 (bottom-left corner of FIG. 1), and a cloud database 106 on the Internet providable by a remote server (not shown).

The uploading side includes a chef-side cooking element 118, a chef-side heating element 116, a Temperature (and/or Pressure) Data Logger 120, and a chef-side computing device 122. The chef-side computing device 122 can comprise a timer and an interface. The downloading side 102 includes a user-side cooking element 108, a heating element 110, a Temperature (and/or Pressure) Controller 112, and a computing device 114. The computing device can comprise a timer and an interface.

In some embodiments, the uploading side can include the Pressure Data Logger 120 instead of, or in combination with Temperature Data Logger 120. Similarly, the downloading side 102 can include the Pressure Controller 112 instead of, or in combination with Temperature Controller 112, for communicating with and controlling the pressure cooker, or other user-side cooking element 108

The downloading side interface can provide output signals to the user and can receive inputs from the user.

The cooking elements can be any regular cooking equipment for use in a regular kitchen, for example, pot, pan, rice cooker, slow cooker, or pressure cooker. The heating element can be any heating equipment for use in a regular kitchen, for example, any electrical or gas operated heating equipment such as hotplate, electric stove or gas range.

The system 100 can include a software application to be installed and run on the computing device. The application can be used both on the uploading side 104 and the downloading side 102. For example, on the uploading side 104, the application can be used to enter details (e.g., ingredients and their appropriate quantify) of a new recipe for recording. On the downloading side 102, the application can be used during cooking to determine a cooking session start time, create a cooking session timeline based on the start time, and provide audio or visual cues for actions such as insertion of ingredients or stirring of contents. Users can view photos or other information related to the recipe provided by the person who submitted the recipe. The application can also be used to select recipes uploaded to and saved in the cloud database 106 on the Internet.

The Temperature (and/or Pressure) Data Logger 120, the Temperature (and/or Pressure) Controller 112, and the computing devices 122 and 114 can each have a communication interface that can connect to the Internet. This connection can be accomplished via a variety of technologies, including but not limited to cable, WiFi, Bluetooth, RFID, NFC (Near Field Communication), ZigBee, or Zwave. The connection between the Internet and the Temperature Data Logger 120 or the Temperature Controller 112 can be a telemetric connection. Telemetry in general relates to remotely monitoring conditions or parameters and the wireless communication of measured quantities for that purpose. Cooking parameters can be recorded and saved, at the uploading side 104, as DNA of Recipe and then uploaded to database 106 located on the Internet cloud. The DNA of Recipe can later be downloaded from the database 106 at the downloading side 102 via user request to reproduce the cooking process.

The system 100 can record the following parameters that define a cooking process. As exemplified in uploading side 104, the system can be designed to record a temperature profile, insertion times and quantities of ingredients, pressure profile, stirring/mixing times, speed and duration.

Temperature Profiles: Food is heated during the cooking process. During this process varying cooking temperature can be required according to the recipe. The temperature profile records the various temperatures and their duration during the cooking. In the graphs 124 shown, temperature is delineated on the Y axis, and time on the X axis. In some embodiments, the temperature can be checked and/or controlled at one second intervals by Temperature Data Logger 120 or the Temperature Controller 112 respectively. In other embodiments, the temperature can be checked and/or controlled at two or three second intervals, for longer time intervals, by Temperature Data Logger 120 or the Temperature Controller 112 respectively.

Insertion of Ingredients: Different ingredients (e.g., spice, oil, meat, or vegetable etc.) may need to be introduced into the cooking element at specific times and temperatures, by different quantities, and in a specific order, according to the recipe. This parameter records these values during the cooking. In the graphs 126 shown, time is again delineated on the X axis, and an insertion time is shown as a slight increase in the direction of the Y axis.

Pressure Profile: If cooking is done using the pressure cooker, the pressure can be automatically recorded. On the other hand, even if no pressure cooker is involved, cooking pressure may vary as a result of opening/closing the lid of the cooking element. This parameter records the times when the lid is opened/closed. In the graphs 128 shown, pressure is delineated on the Y axis, and time on the X axis. In some embodiments, the pressure can be checked and/or controlled at one second intervals by Pressure Data Logger 120 or the Pressure Controller 112 respectively. In other embodiments, the pressure can be checked and/or controlled at two or three second intervals, for longer time intervals, by Pressure Data Logger 120 or the Pressure Controller 112 respectively.

Stirring/Mixing: Stirring/mixing of ingredients in the cooking element may be required by the recipe, at different times. This type of operation can help prevent burning at the bottom of the cooking element, which could, for example, be a cooking vessel, and/or provide proper heat distribution to the ingredients. This parameter records the time, speed and duration of each stirring/mixing. In the graphs 130 shown, time is again delineated on the X axis, and mixing or stirring times are shown as slight increases or decreases in the direction of the Y axis.

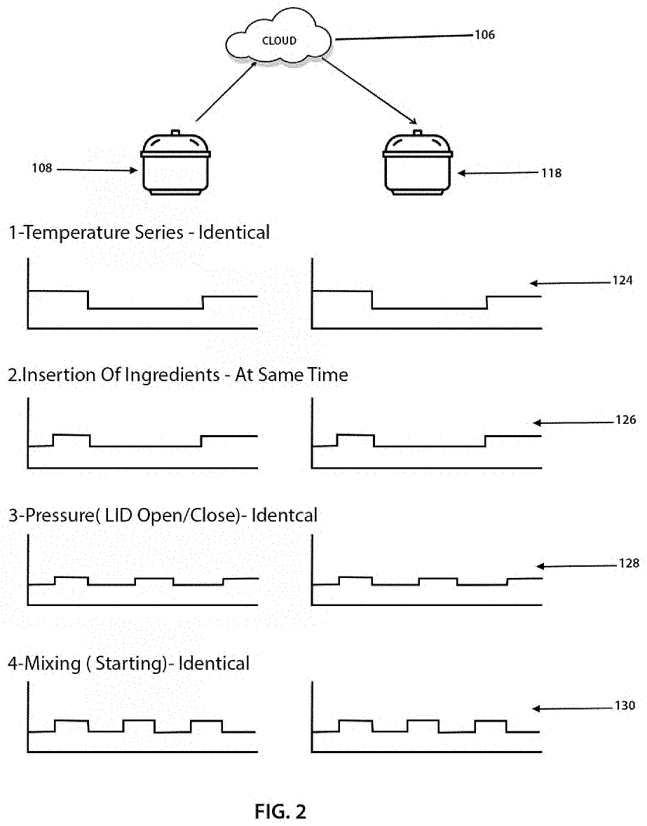

In the graphs of FIG. 2, the left column illustrates the cooking parameter profiles for the DNA of recipe uploaded to the database 106 on the uploading side 104. The right column illustrates the reproduced cooking parameter profiles of the downloading side 102 during the cooking process. As shown in FIG. 2, the cooking parameter profiles on the downloading side 102 match the cooking parameter profiles recorded in the DNA of Recipe on the uploading side 104.

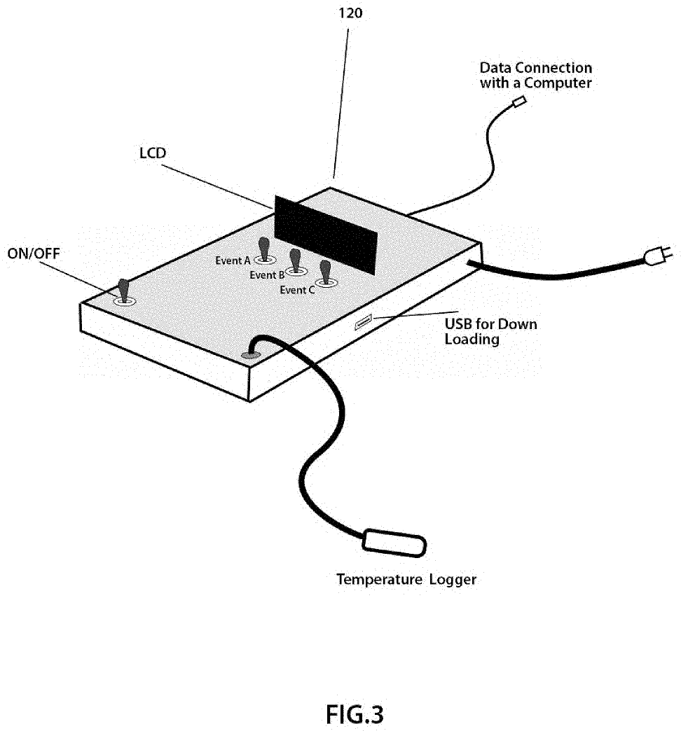

The temperature profile can be automatically recorded using the Temperature Data Logger 120. As shown in FIG. 3, the Temperature Data Logger 120 can have a temperature probe, which can be placed in the proximity of the heating elementor inserted into the cooking element. In some embodiments, probes can be embedded in the heating element. In some embodiments, probes can be embedded in the food. For example, probes may be used to determine the internal temperature of a meat being cooked. The Temperature Data Logger 120 can be configured to read and record the temperature measurements from the temperature probe(s) at predefined intervals during a cooking process. The Temperature Data Logger 120 may have an OFF/ON switch and a LCD display. The LCD can display the current measured temperature and elapsed time since the start of the cooking process. The Temperature Data Logger 120 can be capable of data connection with the computing device 122, so that it can upload its recording of the temperature profile (shown in graph 124), as part of the DNA of Recipe, to the cloud database 106 on the Internet through the computing device. In some embodiments, the Temperature Data Logger 120 can be capable of telemetric connection with the Internet, so that it can upload to the Internet directly through its built-in communication interface using one or more of a variety of technologies, including but not limited to cable, WiFi, Bluetooth, RFID, NFC (Near Field Communication), ZigBee, or Zwave.

The pressure profile can be automatically recorded using the Pressure Data Logger 120. The Pressure Data Logger 120 can communicate with a pressure cooker. The Pressure Data Logger 120 can be configured to read and record the pressure measurements from the pressure cooker at predefined intervals during a cooking process. The Pressure Data Logger 120 can have an OFF/ON switch and a LCD display. The LCD can display the current measured pressure and elapsed time since the start of the cooking process. The Pressure Data Logger 120 can be capable of data connection with the computing device, so that it can upload its recording of the pressure profile (shown in graph 128), as part of the DNA of Recipe, to the cloud database 106 on the Internet through the computing device. In some embodiments, the Pressure Data Logger 120 can be capable of telemetric connection with the Internet, so that it can upload to the Internet directly through its built-in communication interface using one or more of a variety of technologies, including but not limited to cable, WiFi, Bluetooth, RFID, NFC (Near Field Communication), ZigBee, or Zwave.

Insertion of ingredients, opening/closing lid, and stirring/mixing are all cooking events that are important actions/processes to be performed during a cooking process. Other cooking events include, for example, manipulation of utensil, flipping a food item, opening/closing the stove door. Cooking events with an associated time in the cooking temperature profile and/or cooking pressure profile (shown in graphs 124 and 128 respectively) should be recorded in the DNA of Recipe so that they can be performed later by a downloading party to reproduce the cooking process, as shown, for example, in graph 126 of FIG. 2. Optionally, other means may be used to communicate ingredient insertion times to the user. For example, the chef can record instructions, which will then be provided to the user via an audio speaker at the appropriate time to instruct the user to add the appropriate ingredients for that time.

Referring to FIG. 3, the Temperature Data Logger 120 is illustrated in a schematic view. In some embodiments, recording of cooking events can be manually triggered by the user toggling one or more event switches implemented on the Temperature Data Logger 120. For example, when the user inserts an ingredient, the user can toggle the Event A switch, which can be configured to record “ingredient insertion” in the DNA of Recipe; when the use mixes the food, the user can toggle the Event B switch, which can be configured to record “mixing” in the DNA of Recipe.

In some embodiments, recording of cooking events can be manually triggered by the user toggling one or more event switches implemented on the Pressure Data Logger 120. For example, when the user inserts an ingredient, the user can toggle the Event A switch, which can be configured to record “ingredient insertion” in the DNA of Recipe; when the user mixes the food, the user can toggle the Event B switch, which can be configured to record “mixing” in the DNA of Recipe.

In some other embodiments, cooking events can be automatically recorded into database 106. For example, the computing device can be configured to read RFIDs or other computer-readable identifiers. Before cooking, an uploading party can assign and attach RFIDs or other computer-readable identifiers to containers containing the various ingredients to be added. When the uploading party (the chef) adds an ingredient to the cooking element, the uploading party can have the computing device read the RFID or other computer-readable identifier on the container, and automatically record what ingredient is added and when it is added.

Alternatively, a chef monitor including a WebCam can be attached, for example, to the range hood or another location to record the entire cooking process including images of the chef and voice recordings of the chef. The computing device can be configured with an image recognition software that can recognize the materials as they are being added, as well as other cooking events as they are being performed, such as opening/closing lid and stirring/mixing. The WebCam can connect to the computing device so that the computing device can record the time and duration of these cooking events based on what the WebCam captures. The WebCam can also record pre-cooking food preparation or other actions/instructions from the uploading party during the cooking process for the computing device to upload to the cloud database 106 on the Internet, as part of the DNA of Recipe, making it available to downloading parties for reproducing the recipe or cooking process.

In another embodiment, the chef monitor can include a microphone for recording the voice recordings of the chef during the cooking session.

The Temperature Data Logger 120 can have an infrared temperature sensor as well as a thermocouple for measuring the temperature of the heating element, cooking element, or food. The Temperature Data Logger 120 can be coupled to the computer by a wired connection (e.g. a USB) or can be connected directly to the cloud by a Wi-Fi module. As described above, the Temperature Data Logger 120 can measure events by toggling at least one switch. For example, the Temperature Data Logger 120 can have three or more switches for indicating events. The Temperature Data Logger 120 can be used on the uploading side 104 to track cooking parameter profiles for the DNA of Recipe. The Temperature Data Logger can also be used on the downloading side 102 (not shown in FIG. 1) to track cooking parameter profiles during the cooking process to ensure that the user is following the DNA of Recipe uploaded on the uploading side 104.

On the downloading side 102, the Temperature Controller 112 can be used to reproduce the cooking process of a recipe based on a downloaded DNA of Recipe from the cloud database 106 on the Internet.

The Pressure Data Logger 120 can have a pressure sensor for measuring the pressure in a pressure cooker. The Pressure Data Logger 120 can be coupled to the computer by a wired connection (e.g. a USB) or can be connected directly to the cloud by a Wi-Fi module. As described above, the Pressure Data Logger 120 can measure events by toggling at least one switch. For example, the Pressure Data Logger 120 can have three or more switches for indicating events. The Pressure Data Logger 120 can be used on the uploading side 104 to track cooking parameter profiles for the DNA of Recipe. The Pressure Data Logger 120 can be used on the downloading side 102 to track cooking parameter profiles during the cooking process to ensure that the user is following the DNA of Recipe uploaded on the uploading side 104.

On the downloading side 102, the Pressure Controller can be used to reproduce the cooking process of a recipe based on a downloaded DNA of Recipe from the cloud database 106 on the Internet.

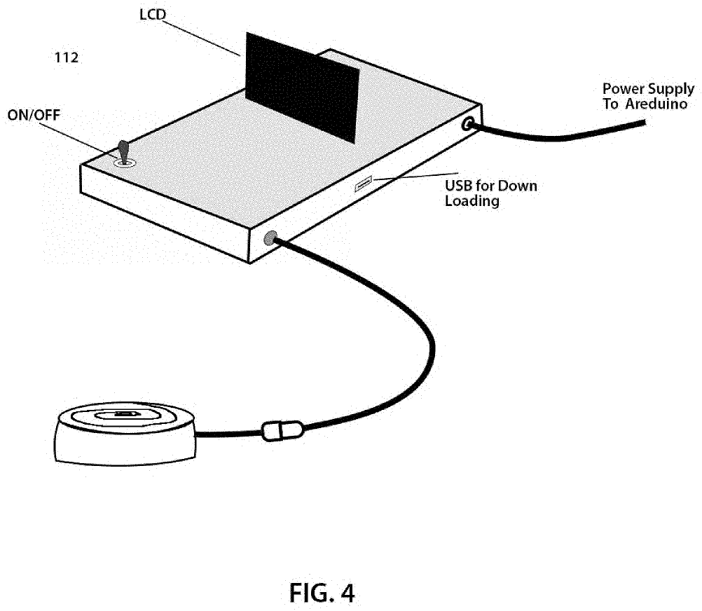

As shown in FIG. 4, Temperature Controller 112 can be connected to a heating element (e.g., the hotplate). The Temperature Controller 112 can have an OFF/ON switch and a LCD display. The Temperature Controller 112 can control the heating element to reproduce the temperature profile in the downloaded DNA of Recipe. The LCD can display, for example, the current temperature and elapsed time.

In some embodiments, the LCD display can provide a temperature-change signal to the user indicating a required change to the cooking temperature at the cooking element. When the user confirms the temperature change via input to the interface, the temperature controller changes the cooking temperature at the cooking element.

In some embodiments, the LCD display can provide a temperature-change signal to the user instructing the user to change the cooking temperature at the cooking element.

In some embodiments, the Temperature Controller 112 can control the temperature on the heating element by varying the current flowing into the heating element. The current can be varied using a proportional-integral-derivative (PID) control algorithm. The Temperature Controller 112 can have a low voltage power input, but can use a solid state relay to increase the voltage to 116 or 220 Volt, capable of producing enough output current to drive the heating element. The Temperature Controller 112 can also include a thermocouple or temperature probe to be inserted into the cooking element, the heating element, or the food to provide temperature feedback to the Temperature Controller.

In some embodiments, the heating element 110 may be a gas range. In those embodiments, the Temperature Controller 112 can drive a servomotor, or other types of actuators allowing for precise control of angular position, velocity and acceleration, to turn the gas valve on the range in rotatory motion to control the output temperature.

A Pressure Controller can be connected to a pressure cooker. The Pressure Controller can have an OFF/ON switch and a LCD display. The Pressure Controller can control the pressure cooker to reproduce the pressure profile (as shown, for example, in graph 128) in the downloaded DNA of Recipe. The LCD can display, for example, the current pressure and elapsed time.

In some embodiments, the LCD display can provide a pressure-change signal to the user indicating a required change to the cooking pressure at the pressure cooker. When the user confirms the pressure change via input to the interface, the pressure controller 112 can change the cooking pressure at the pressure cooker.

In some embodiments, the LCD display can provide a pressure-change signal to the user instructing the user to change the cooking pressure at the pressure cooker.

In some embodiments, the Pressure Controller can control the pressure in the pressure cooker by varying the current flowing into the pressure cooker. The current can be varied using a proportional-integral-derivative (PID) control algorithm. The Pressure Controller can have a low voltage power input, but can use a solid state relay to increase the voltage to 116 or 220 Volt, capable of producing enough output current to drive the pressure cooker.

In some embodiments, there can be one or more indicator lights (e.g., LED #1-#3 or more), each indicator light corresponding to a cooking event (e.g., inserting ingredients, opening/closing the lid of the cooking element, or stirring/mixing ingredients). In some embodiments, these indicator lights can serve to prompt the user to perform certain cooking events. For example, LED #1 can prompt the user to stir or mix, LED #2 can prompt the user to open or close the lid, and LED #3 can prompt the user to add ingredients.

In some embodiments, the LCD can be configured to display, in addition to temperature, pressure, and time, the occurrence of the cooking events. The LCD can display images of the chef and the occurrence of the cooking events at different times corresponding to the start time of the cooking session.

Further, the Kookken™ system can be configured to provide audible or visual notifications (e.g., audible alarm or flashing light) to remind a user to initiate or terminate certain cooking events. The audible notifications can include the voice recordings of the chef at corresponding times during the user cooking session. In this way, the system can help the user be in synch with the recorded timings in the DNA of Recipe.

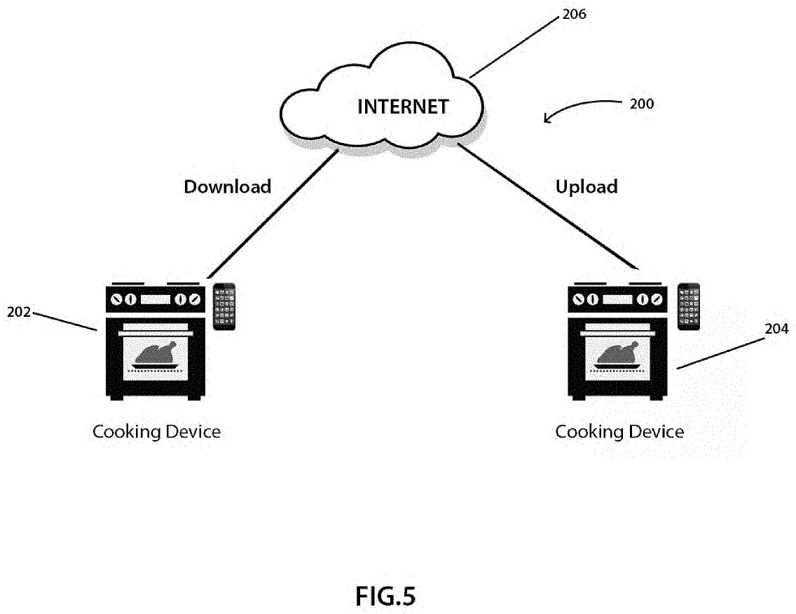

As described above, in some embodiments, the cooking or heating element can directly communicate with the Internet. For simplicity, the cooking element, heating element, or both may be referred to as a cooking device. Referring to FIG. 5, there is illustrated a computer-implemented system 200 in accordance with another embodiment of the present invention. The system 200 comprises a chef-side cooking device 204, a user-side cooking device 202 and a cloud database 206. The cooking devices 202 and 204 can be “smart” stoves connected to the Internet. The “smart” stoves can be capable of automatically monitoring and adjusting the cooking parameters and conditions of the stove. The DNA of Recipe can be uploaded to the Internet directly from the “smart” stove 204. The DNA of Recipe can be downloaded directly to the “smart” stove 202 from the Internet.

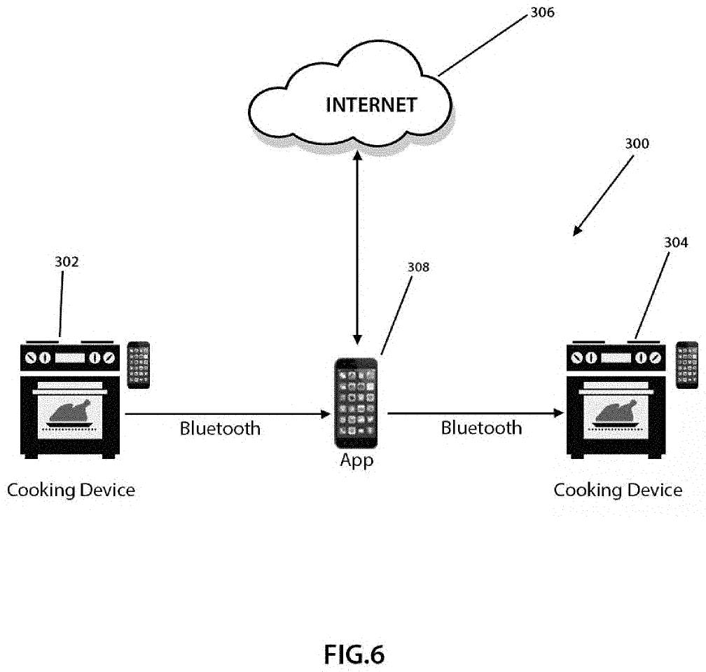

Referring to FIG. 6, there is illustrated a computer-implemented system 300 in accordance with another embodiment of the present invention. In some embodiments, the cooking device can communicate directly with the computing device and indirectly link to the Internet. For example, as shown in FIG. 6, the cooking device communicates with the computing device by way of Bluetooth. The system 300 comprises a chef-side cooking device 302, a user-side cooking device 304, a cloud database 306 and computing application 308. The computing application 308 can be located chef-side and/or user-side on separate computing devices. The computing application 308 can then provide a link to the Internet. It will be appreciated that the communication interface can include, but is not limited to, WiFi, Bluetooth, RFID, NFC (Near Field Communication), ZigBee, or Zwave.

In this example, once a Bluetooth connection is made between the computing application 308 and the cooking device 304, the software application (or “app”) described previously may be used to control the cooking device 304. For example, as described above, the app 308 can be used on the uploading side to enter details and record parameters of a new recipe. On the downloading side, the app 308 can be used during cooking to provide audio or visual cues. The app 308 can also control the temperature, pressure, or other cooking parameters or conditions by way of the Bluetooth connection to the cooking device.

In some embodiments, the app 308 can request permission from the user before changing the cooking parameter or condition of the cooking device. By requesting permission to change the cooking parameter or condition, the user can verify that the change to the cooking parameter or condition is appropriate for the type of food being cooked. In some embodiments, the app 308 can automatically change the cooking parameter or condition of the cooking device. By automatically changing the cooking parameter or condition, the food may be cooked with less input from the user. The user can perform other tasks while the food is cooking.

In some embodiments, the cooking device can be retrofitted with a communication interface. As exemplified in FIG. 6, the cooking devices 302 and 304 are not “smart” and thus cannot communicate with the computing device or the Internet. The cooking devices have been retrofitted with Bluetooth communications that allow for communication with the computing device. Indirectly connecting to the Internet through a computing device can reduce equipment costs, as the cooking device does not need to be “smart”.

Indirectly connecting to the Internet through a computing device can also improve the security of the cooking device. In examples where the cooking device is “smart”, it may be possible for the cooking device to be hacked or interfered with when the user is unavailable to monitor the device. In the Bluetooth example of FIG. 6, the user must have their computing device present in order for the DNA of Recipe to be accessed. As such, when the computing device is not present, the cooking device does not have a link to the Internet, and cannot be hacked.

The present invention has been described here by way of example only. Various modification and variations may be made to these exemplary embodiments without departing from the spirit and scope of the invention, which is limited only by the appended claims.

As described above, devices such as the Temperature Data Logger 120 and the Temperature Controller 112 can be implemented and incorporated into “smart” ranges by range manufacturers. These smart ranges and other potential embodiments of the present invention can appeal to a large number of potential users in the online community, from commercial kitchens as well as residential kitchens. For example, in addition to publishing recipes in cookbooks, professional chefs can publish the recipes' corresponding DNAs of Recipe on their Facebook accounts or other dedicated online spaces, to further their readers' understanding of and experience with the recipes. In another example, “foodies” can share their own recorded DNAs of Recipe online, for example, on foodchannel.com, Pinterest, and/or Yelp, to facilitate discussion and learning around them.

Devices such as the Pressure Data Logger 120 and the Pressure Controller 112 can be implemented and incorporated into “smart” pressure cookers by pressure cooker manufacturers. These smart pressure cookers and other potential embodiments of the present invention can appeal to a large number of potential users in the online community, from commercial kitchens as well as residential kitchens. For example, in addition to publishing recipes in cookbooks, professional chefs can publish the recipes' corresponding DNAs of Recipe on their Facebook accounts or other dedicated online spaces, to further their readers' understanding of and experience with the recipes. In another example, “foodies” can share their own recorded DNAs of Recipe online, for example, on foodchannel.com, Pinterest, and/or Yelp, to facilitate discussion and learning around them.

DNAs of Recipe described in the present invention can expand commercial opportunities available to people in the food industry, such as celebrity chefs. For example, a particular celebrity chef may be most famous for several dishes. She may record her DNA of Recipe for one dish and sell copies to users at a certain price; she may make it available through one or more of her online spaces to online subscribers pay per download and/or, probably at a slightly lower price, pay per view. She may record DNAs of Recipe for each of her famous dishes and offer them for sale, online or offline, at different prices depending on, for example, the length of the recording, the complexity of making the dish, and/or the relative popularity of the dish among users and/or subscribers. On some occasions, she may provide one or more of these DNAs of Recipe to a selected group of users and/or subscribers, for a limited time, at a special discount price or even for free.

1. A computer-assisted cooking method, the method comprising:
operating a chef-side computer system to collect cooking session information from a chef cooking session, wherein the chef-side computer system comprises a temperature data logger, a communication link, a chef-side timer and a chef interface, and operating the chef-side computer system to collect the cooking session information from the chef cooking session comprises
linking the temperature data logger to a chef cooking element to automatically track a temperature at the chef cooking element, to provide a cooking temperature profile indicating a cooking temperature during any time interval during the chef cooking session, including any changes in cooking temperature during the time interval; and,
operating the chef interface to define a plurality of ingredients, and to track a plurality of cooking events during the chef cooking session, wherein the plurality of cooking events comprises at least one of i) stirring at least one ingredient being heated at the chef cooking element, ii) adding at least one ingredient to be heated at the chef cooking element, and iii) changing a cooking parameter at the chef cooking element, wherein each cooking event in the plurality of cooking events comprises an associated time in the cooking temperature profile;
uploading to, and storing on, a remote server the cooking session information comprising the cooking temperature profile, the plurality of ingredients, and the plurality of cooking events; and
receiving at the remote server, a request from a user-side computer system for the cooking session information, and, in response, downloading the cooking session information comprising the cooking temperature profile, the plurality of ingredients, and the plurality of cooking events to the user-side computer system.

2. The method as defined in claim 1 further comprising operating the user-side computer system to facilitate a user cooking session, wherein the user-side computer system comprises a user-side processor, user-side timer and a user-side interface, and operating the user-side computer system to facilitate the user cooking session comprises
determining a start time of the user cooking session;
based on the start time, operating the user-side computer system to determine a user-side timeline for the user cooking session;
based on the cooking temperature profile, operating the user-side computer system to determine changes to a cooking temperature at a user cooking element during the user-side timeline for the user cooking session; and
based on the plurality of ingredients and the plurality of cooking events, operating the user-side computer system to determine a plurality of user-side cooking events during the user-side timeline for the user cooking session.

3. The method as defined in claim 2 wherein
the user-side interface comprises a temperature controller for communicating with the user cooking element; and,
operating the user-side computer system to determine changes to the cooking temperature at the user cooking element during the user-side timeline for the user cooking session comprises linking the temperature controller to the user cooking element to automatically change the cooking temperature at the user cooking element during the user-side timeline for the user cooking session.

4. The method as defined in claim 2 wherein
the user-side interface comprises a temperature controller for communicating with the user cooking element;
the user-side interface a user-side input/output for providing signals to the user and receiving input from the user; and,
operating the user-side computer system to determine changes to the cooking temperature at the user cooking element during the user-side timeline for the user cooking session comprises providing a temperature-change signal to the user via user-side input/output, and, when user-side input/output receives input from the user confirming the temperature change, operating the temperature controller to change the cooking temperature at the user cooking element during the user-side timeline for the user cooking session.

5. The method as defined in claim 2 wherein
the user-side interface comprises a user-side input/output for providing signals to the user; and,
operating the user-side computer system to determine changes to the cooking temperature at the user cooking element during the user-side timeline for the user cooking session comprises providing a temperature-change signal to the user via user-side input/output, instructing the user to change the temperature of the user cooking element.

6. The method as defined in claim 2 wherein
the user-side interface comprises a user-side input/output for providing signals to the user; and,
operating the user-side computer system to determine the plurality of user-side cooking events during the user-side timeline for the user cooking session comprises, at different points along the user-side timeline, providing a plurality of different cooking event signals to the user via user-side input/output, instructing the user to perform the plurality of different cooking events.

7. The method as defined in claim 2 wherein the chef interface a chef monitor for monitoring the chef during the chef cooking session.

8. The method as defined in claim 7 wherein
the cooking session information further comprises image recordings including a plurality of images of the chef and at least some of the plurality of cooking events at different cooking event times during the chef cooking session; and,
the chef monitor comprises a camera for recording the plurality of images of the chef and at least some of the plurality of cooking events at the different cooking event times during the chef cooking session.

9. The method as defined in claim 8 wherein
the cooking session information further comprises a plurality of voice recordings of the chef at different voice recording times during the chef cooking session; and,
the chef monitor further comprises a microphone for recording the voice recordings of the chef during the chef cooking session.

10. The method as defined in claim 8 wherein
the user-side interface further comprises a screen for displaying images; and,
operating the user-side computer system to facilitate the user cooking session further comprises, based on the start time and the different cooking event times during the chef cooking session, displaying images of the chef and the at least some of the plurality of cooking events on the screen at corresponding times during the user cooking session.

11. The method as defined in claim 9 wherein
the user-side interface further comprises a screen for displaying images, and a speaker for providing sound; and,
operating the user-side computer system to facilitate the user cooking session further comprises, based on the start time, the different cooking event times during the chef cooking session, and the different voice recording times during the chef cooking session, displaying images of the chef and the at least some of the plurality of cooking events on the screen, and playing the voice recordings of the chef on the speaker at corresponding times during the user cooking session.

12. The method as defined in claim 3 wherein
the chef cooking element is a chef-side pressure cooker;
the user cooking element is a user-side pressure cooker;
the chef-side computer system comprises a pressure data logger;
the user-side interface comprises a pressure controller for communicating with the user-side pressure cooker;
operating the chef-side computer system to collect the cooking session information from the chef cooking session further comprises operating the pressure data logger to track a pressure at the chef-side pressure cooker to provide a cooking pressure profile for indicating a cooking pressure during any time interval during the chef cooking session, including any changes in cooking pressure during the time interval;
based on the cooking pressure profile, operating the user-side computer system to change a cooking pressure at the user-side pressure cooker during the user-side timeline for the user cooking session.

13. The method as defined in claim 3 wherein the temperature data logger comprises a temperature probe for inserting into food being cooked at the chef cooking element.

14. A computer-assisted cooking method, the method comprising:
downloading from a remote server to a user-side computer system, cooking session information comprising a cooking temperature profile, a plurality of ingredients, and a plurality of cooking events;
operating the user-side computer system to facilitate a user cooking session using the cooking session information, wherein the user-side computer system comprises a user-side processor, user-side timer and a user-side interface, and operating the user-side computer system to facilitate the user cooking session comprises
determining a start time of the user cooking session;
based on the start time, operating the user-side computer system to determine a user-side timeline for the user cooking session;
based on the cooking temperature profile, operating the user-side computer system to determine changes to a cooking temperature at a user cooking element during the user-side timeline for the user cooking session; and
based on the plurality of ingredients and the plurality of cooking events, operating the user-side computer system to determine a plurality of user-side cooking events during the user-side timeline for the user cooking session.
